(19) United States
(12) Patent Application Publication
(10) Pub. No.: US 2008/0196781 A1
(43) Pub. Date: Aug. 21, 2008

(54) Ehaust Pipe Section

(76) Inventor: Bernhard Grescher, Fischach (DE)

Correspondence Address: PAMELA A. KACHUR, 950 W 450 S, BLDG. 4, COLUMBUS, IN, 47201, US

(21) Appl. No.: 11/911,988

(22) PCT Filed: Apr. 18, 2006
(86) PCT No.: PCT/EP2006/003515

§ 371 Date: Jan. 10, 2008

(30) Foreign Application Priority Data
Apr. 22, 2005 (DE) 10 2005 018 881.8

(51) Int. Cl. F01N 7/00; F01N 7/08; F16L 41/00; F16L 55/07

(52) U.S. Cl. 138/106; 138/109

(57) ABSTRACT

An exhaust gas pipe has a wall and a connecting piece fastened to it. A functional part, such as a probe, is received into the connecting piece. The connecting piece has a formed-on, unworked protrusion for fastening the functional part.

The invention relates to an exhaust gas pipe section, in particular of internal combustion engines.

In vehicular internal combustion engines, various probes for detecting exhaust gas parameters may be provided, for instance Lambda probes, pressure sensors, temperature sensors and the like. By means of these probes, for instance, the injection process of the internal combustion engines or also the post-processing of the exhaust gas, e.g. the regeneration of carbon-particle filters of diesel engines is controlled. For supporting a probe there is provided a probe connecting piece which in DE 42 24 251 C1 has an end section which has the shape of a spherical calotte, partially projects into the exhaust gas pipe and is fastened to the wall. Due to this shape the probe connecting piece can be produced as a standard piece, because it can be welded to the wall with the most various angular orientations, depending on the installation space which is available in each case. Furthermore, it is possible that on a connecting piece functional parts other than probes are in communication with the interior of the exhaust gas pipe, e.g. pressure lines or injection elements.

It is the object of the invention to provide an exhaust gas pipe section with a connecting piece which is produced more cost-efficiently.

The exhaust gas pipe section according to the invention has a wall and a connecting piece which is fastened to the wall and projects through a wall opening into an exhaust gas pipe, an end portion associated to the connecting piece and projecting into the exhaust gas pipe, being fastened to the wall and having a stepless convex curvature and the connecting piece having an opening for receiving a functional part, in particular a probe, and in the region of the opening at least one formed-on, unworked fastening protrusion for arresting the functional part.

This fastening protrusion is preferably a screw thread, in particular a fine pitch thread.

Up until now it was conceived only to mechanically machine the connecting piece, e.g. to cut an appropriate fine pitch thread, in order to provide for a sufficient tightness for the probe. The invention uses another method. It makes provision that the fastening protrusion is unworked, in particular is not machined. With this, the production costs of the connecting piece and, hence, of the entire exhaust gas pipe section can be reduced.

According to a variation of the invention the connecting piece is also unworked in the region of the outer surface of the end section.

The connecting piece may even be unworked as a whole, whereby the production expense can be further reduced.

Several different designs of the connecting piece are possible.

According to a first embodiment the connecting piece is a powder-metallurgical product, e.g. a sintered product. Here, very smooth surfaces and exact protrusions can be formed.

A second embodiment makes provision that the connecting piece is a cast product, in particular a precision casting. Where applicable, it is required here that in the region of the end section potentially occurring cast wastes are removed by deburring.

In a third embodiment the connecting piece is made of a metal foam. The advantage of the metal foam is that its thermal conductivity is reduced compared to solid material.

All these production methods have in common that the connecting piece is produced in a mold; for this reason, the fastening protrusion can be produced by means of the mold in tight limits already during production of the connecting piece.

The above-mentioned methods of producing the connecting piece allow in part the production of the connecting piece with sections having different material properties. It is possible especially by means of the powder-metallurgical production method that an outer layer in the region of the end section can be produced, which e.g. allows a good soldering joint between the connecting piece and the wall.

The connecting piece in the region of the outer peripheral surface can have, compared with the region of the protrusion, in more general terms, a higher temperature resistance and/or a lower mechanical strength and/or a lower density.

Concerning the end section, it should be configured similar to prior art, namely to the effect that it can be directly fastened to the rim of the wall opening with different angular orientations relative to the wall, in fact without the necessity for the provision of an adapter piece or the like. The wall in the region of the opening should also be configured without any specific machining in the sense of a specific profiling which aims at a desired angular orientation.

The connecting piece itself is fastened to the wall by welding, soldering or gluing.

Further features and advantages of the invention will be apparent from the following description and the following drawings to which reference is made and in which:

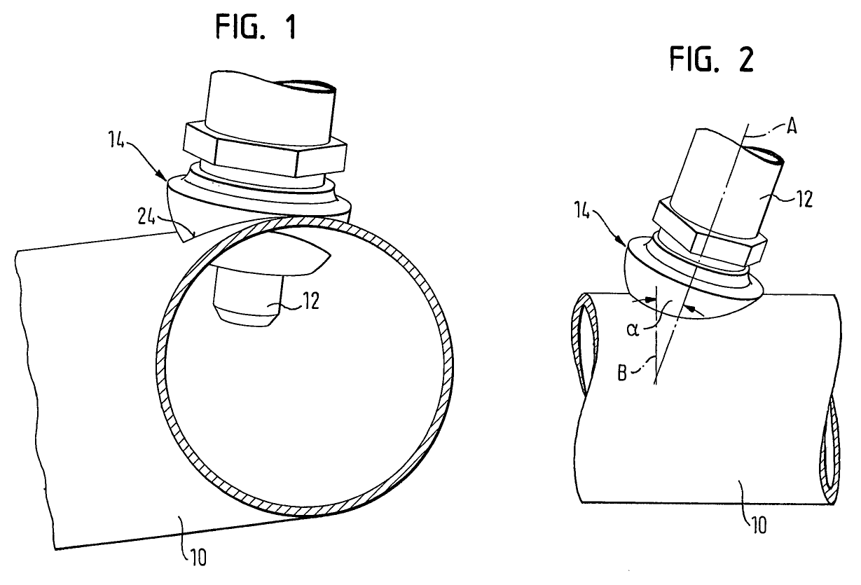

FIG. 1 is a perspective view of a broken exhaust gas pipe section according to the invention, with a probe fastened thereto,

FIG. 2 is a side view of the exhaust gas pipe section according to FIG. 1,

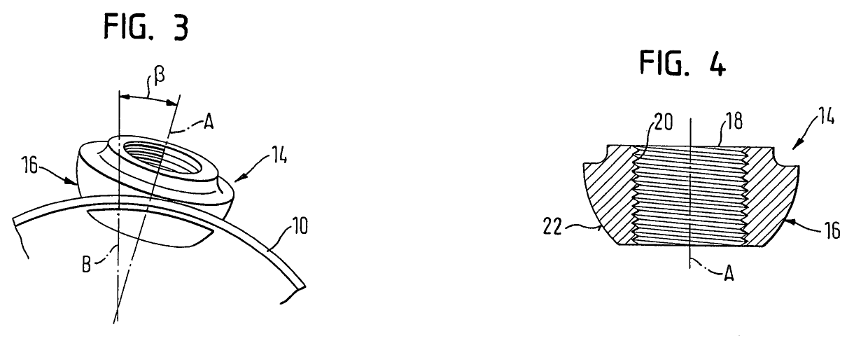

FIG. 3 is an end view of a portion of the exhaust gas pipe section according to FIG. 1, without the probe, and

FIG. 4 is a longitudinal section view through the connecting piece used in the exhaust gas pipe section according to the invention.

FIG. 1 illustrates an exhaust gas pipe section of a vehicular internal combustion engine. The entire exhaust gas pipe is defined by an exhaust tube with a cylindrical wall 10. Projecting into the interior of the tube, i.e. into the exhaust gas pipe, is a functional part in the form of a probe 12, in the present case a Lambda probe. The functional part, however, may also be a pressure line or an injection element. The exhaust gas pipe section has a connecting piece 14 for positioning and arresting the probe 12, as it is shown in detail in FIG. 4.

The connecting piece 14 has an end section 16 with a continuous stepless convex curvature, and a central opening 18 with an internal thread 20, which in particular is a fine pitch thread.

The convexly curved end section 16 has the shape of a spherical calotte in the embodiment which is shown. It would also be possible, however, that it takes other shapes which are symmetrical or non-symmetrical to the central axis A, e.g. in the widest sense it may be egg-shaped or dome-shaped. As a part of this end section 16 projects into the interior of the exhaust gas pipe, as can be seen in FIG. 1, the curvature of the end section 16 should be designed with regard to a flow resistance which is as low as possible and in view of low turbulences.

The connecting piece 14 is preferably a product made by powder metallurgy, e.g. a sintered product made in one piece. The fastening protrusion, here the internal thread 20, for the fastening of the sensor 12, is produced at the surface without any further fashioning (in particular without any metal-cutting working) directly during sintering or the like, i.e. after the protrusion has been made, it will not undergo any further treatment on its surface.

The outer peripheral surface 22 of the convex end section 16 also remains unworked. In the embodiment which is shown, the complete outer surface of the connecting piece 14 is completely unworked at all, making the connecting piece 14 very cost-efficient in its production.

The connecting piece 14 may also be produced by casting, in particular by precision casting or, as an alternative to this, can be made from metal foam.

By these described methods it is possible to produce sections of the connecting piece 14 with different material properties. For example, the connecting piece 14 may have—in the region of the outer peripheral surface 22, with which it also projects into the interior of the exhaust gas pipe—a higher temperature resistance than in the region of the screw thread. It is in the region of the outer peripheral surface 22 that a lower mechanical strength and/or a lower density could be provided than in the region of the internal thread or in other regions, depending on the material properties which are necessary in the respective sections.

Due to the convex design of the end section the connecting piece 14 can be inserted in the wall 10 with different angular orientations relative to it. The central axis B extends centrally through the opening 24 and intersects the longitudinal axis of the exhaust gas pipe. In the side view (FIG. 2) it can be seen that the central axis A defines an angle α with the central axis B, and in an axial view (FIG. 3) the axes A and B make an angle β between them. The angles α and β may range from about −20° to +20°.

The production of the opening 24 is performed preferably by laser-cutting; in this process, the wall 10 does not have to be flattened in order to provide a sufficiently good fit for the connecting piece 14.

The connecting piece 14 is positioned in the desired angular orientation and directly welded, soldered or glued to the wall 10 at the rim of the opening 24. The welding can be done e.g. capacitor discharge welding or by frictional welding whilst pressing the connecting pieces 14 into the wall 10.

1.-10. (canceled)

11. An exhaust gas pipe section, comprising
a wall and
a connecting piece fastened to the wall and projecting through a wall opening into the exhaust gas pipe section,
wherein an end portion of the connecting piece projects into the exhaust gas pipe section and is fastened to the wall, the end portion having a stepless convex curvature, and
wherein the connecting piece further has an opening for receiving a functional part, and at least one formed-on, unworked fastening protrusion for securing the functional part in the opening.

12. The exhaust gas pipe section according to claim 11, wherein the fastening protrusion is a screw thread.

13. The exhaust gas pipe section according to claim 11, wherein the entire connecting piece (14) is unworked.

14. The exhaust gas pipe section according to claim 11, wherein the connecting piece is a powder-metallurgical product.

15. The exhaust gas pipe section according to claim 11, wherein the connecting piece is a cast product

16. The exhaust pipe section according to claim 11, wherein the connecting piece is a precision cast product.

17. The exhaust gas pipe section according to claim 11, wherein the connecting piece is made of a metal foam.

18. The exhaust gas pipe section according to claim 11, wherein the connecting piece has sections with differing material properties.

19. The exhaust gas pipe section according to claim 11, wherein the connecting piece, in the region of its outer peripheral surface, has a higher temperature-resistance than in the region of the protrusion.

20. The exhaust gas pipe section according to claim 11, wherein the connecting piece, in the region of its outer peripheral surface, has a lower mechanical strength than in the region of the protrusion.

21. The exhaust gas pipe section according to claim 11, wherein the connecting piece, in the region of its outer peripheral surface, has a lower density than in the region of the protrusion.

22. The exhaust gas pipe section according to claim 11, wherein the end section is configured to be convex so that the connecting piece can be fastened at the rim of the wall opening with different angular orientations relative to the wall.

23. The exhaust gas pipe section according to claim 11, wherein the connecting piece is fastened to the wall by welding, soldering or gluing.

24. The exhaust gas pipe section according to claim 11, wherein the functional part comprises a probe.
